(19) United States
(12) Patent Application Publication
(10) Pub. No.: US 2008/0303810 A1
(43) Pub. Date: Dec. 11, 2008

(54) SYSTEM AND METHOD FOR CALCULATING LOFT SURFACES USING 3D SCAN DATA

(76) Inventors: Seockhoon Bae, Cupertino, CA (US); Donghoon Lee, Seoul (KR); Sungwook Cho, Bucheon (KR); Seungyob Kim, Seoul (KR); Changyoon Yang, Sungnam City (KR)

Correspondence Address: LAHIVE & COCKFIELD, LLP;FLOOR 30, SUITE 3000, ONE POST OFFICE SQUARE, BOSTON, MA, 02109, US

(21) Appl. No.: 11/759,641

(22) Filed: Jun. 7, 2007

(51) Int. Cl. G06T 15/00

(52) U.S. Cl. 345/419

(57) ABSTRACT

A mechanism for automatically calculating loft surfaces from raw 3D scan data represented as a mesh or point cloud model is discussed. Users enter parameters related to the loft surface calculation via a provided user interface. User input and/or programmatically calculated parameters may include U-V direction, guide curve identification, and the amount of allowable deviation error between the calculated loft surface and the 3D scan data. Profile curves meeting the given parameters are then generated and a loft surface is calculated using the generated profile curves for a selected region. The user may select geometrically separated regions in order to create a single loft surface that connects the separate regions.

### FIELD OF THE INVENTION

The embodiments of the present invention relate generally to CAD (Computer Aided Design) and more particularly to reverse engineering 3D scan data to calculate loft surfaces using 3D scan data.

### BACKGROUND

Computer Aided Design (CAD) applications are used to produce computer models of two and three dimensional objects as part of the production process for the actual physical device being modeled. The models frequently include multiple parts which must be individually designed. The designer of the model parts may use specialized modeling features in order to design the model parts. Once the designer is satisfied with the design, the actual physical device may be produced using the model. 3D scanning captures physical geometry information for a three-dimensional object by gathering high resolution points representing the shape of the scanned three-dimensional object. Once captured, the raw 3D scan data may be converted to a CAD part model for further processing to replicate or modify the design of the three-dimensional object. This procedure of capturing 3D scan data for a three-dimensional object in order to provide it to a CAD application so that the object may be redesigned is referred to as reverse engineering.

One reverse engineering technique is to draw planar cross section curves or feature curves on a 3D scanned geometry from which a loft surface is constructed. A loft surface is a polynomial surface passing through given “profile curves” while some iso-lines (lines(curves) that represent a constant surface parameter ( U or V)) are also following given “guide curves”. Guide curves provide a constraint between profiles. The loft surface is created on the guide curves Surface designers control the curvature and the smoothness of a loft surface by modifying the profile or guide curves that intersect the loft surface. Unfortunately, the process of redesigning a loft surface model that replicates 3D scan data geometry requires a user to perform repetitive manual modeling techniques with currently available 3D modeling software.

### BRIEF SUMMARY

The embodiments of the present invention automatically calculate loft surfaces from raw 3D scan data. Users enter parameters related to the loft surface calculation via a provided user interface. User input parameters may include U-V direction, guide curve identification, and the amount of allowable deviation error between the calculated loft surface and the 3D scan data. Profile curves meeting the given parameters are then generated and a loft surface is calculated using the generated profile curves for a selected region. The user may select geometrically separated regions in order to create a single loft surface that connects the separate regions.

In one embodiment, a method for creating loft surfaces using 3D scan data includes providing a collection of 3D scan data representing the shape of a three dimensional object. The 3D scan data is combined into a model representing the three dimensional object. The method segments the model into multiple regions. One or more regions are selected for programmatic calculation of a loft surface. The loft surface is programmatically calculated and fitted to the 3D scan data.

In another embodiment, a system for use with a computing device that programmatically creates loft surfaces using 3D scan data includes a collection of 3D scan data representing the shape of a three dimensional object. The 3D scan data is combined into a model representing the three dimensional object. The model is segmented into a multiple regions. The system also includes a loft calculation facility for programmatically calculating a loft surface fitted to the 3D scan data for at least one of the regions. The system additionally includes a display device that displays a user interface. The user interface enables a selection of at least one parameter related to the programmatic calculation of the loft surface.

### BRIEF DESCRIPTION OF THE DRAWINGS

The invention is pointed out with particularity in the appended claims. The advantages of the invention described above, as well as further advantages of the invention, may be better understood by reference to the following description taken in conjunction with the accompanying drawings, in which:

FIG. 1 depicts an exemplary environment suitable for practicing an embodiment of the present invention;

FIG. 2 is a flowchart of a sequence of steps that may be followed by an embodiment of the present invention to programmatically calculate a loft surface;

FIG. 3 (prior art) depicts sample 3D scan data represented in a triangular mesh;

FIG. 4 (prior art) depicts the grouping of a mesh into regions with similar curvature ranges;

FIG. 5A depicts the application of cross section curves to a model;

FIG. 5B depicts the excising of cross section curves from an area of a model;

FIG. 5C depicts the reconnection of broken cross section curves in an area of a model;

FIG. 5D depicts the extension of cross section curves;

FIG. 5E depicts the trimming of the ends of cross section curves;

FIG. 5F depicts the use of cross section curves as section profiles when defining a loft surface;

FIG. 5G depicts the approximation of a loft surface with a straight iso-curve flow.

FIG. 6 depicts the selection of geometrically separate model regions in an embodiment of the present invention;

FIG. 7 depicts the selection of a U-V direction in an embodiment of the present invention;

FIG. 8 depicts the use of guide curves in an embodiment of the present invention;

FIG. 9A depicts the projection of a feature curve on an unguided loft surface by an embodiment of the present invention;

FIG. 9B depicts the intersection nodes between projected guide curves of FIG. 9A and profile curves on an unguided loft surface by an embodiment of the present invention; and

FIG. 9C depicts a final resulting loft surface calculated from an initial unguided loft surface.

### DETAILED DESCRIPTION

The embodiments of the present invention enable the programmatic calculation of a loft surface for a selected model region or regions of 3D scan data. The programmatic calculation of the loft surface may be based on user input parameters. A graphical user interface is provided that enables a user to select a region or regions on which a loft surface will be created. As input arguments, users also can specify U-V direction, guide curves and allowable deviation error. The loft calculation facility generates all necessary profile curves meeting specified parameters and creates a loft surface. The initial profiles and guide curves may be automatically suggested from mesh parameterization calculated directly from the selected mesh region or regions or from re-meshed regions. When selecting a region, users can choose geometrically separated regions in order to create a single loft surface connecting the regions together. In one embodiment following the user selection of a region or regions, the necessary input conditions for loft calculation are calculated from supplied region information. If the region is suitable for lofting, its principal curvature flows are calculated from the mesh. From the curvature flows, the regions are parameterized so as to extract necessary profiles from V-directional iso-parametric curves, and necessary guide curves from U-directional iso-parametric curves (it will be appreciated that the use of the U and V directional iso-parameteric curves can also be reversed when performing the parameterization).

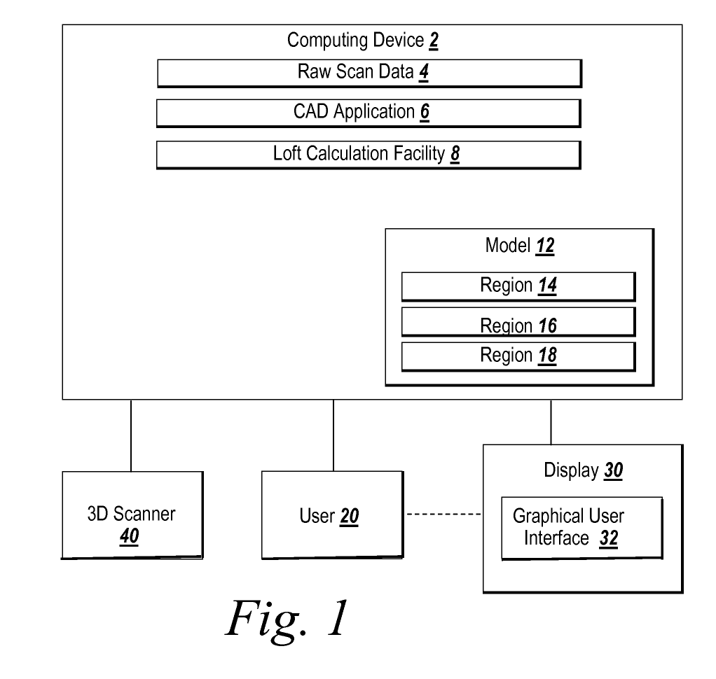

FIG. 1 depicts an exemplary environment suitable for practicing an embodiment of the present invention. A computing device 2 includes a collection of raw 3D scan data 4 for a scanned three-dimensional object. The raw 3D scan data 4 is collected from a 3D scanner 40. The computing device 2 also hosts a CAD application 6 and a loft calculation facility 8. The computing device 2 may be a workstation, server, laptop, mainframe, PDA, a cluster of devices operating together, a virtual device or another computing device able to support the CAD Application 6 and loft calculation facility 8 discussed herein. The loft calculation facility 8 is an executable software process or processes that are explained further below. The loft calculation facility 8 may be implemented as one or more application processes, one or more application plug-ins, stand-alone applications or other form of executable code. In one implementation of the present invention, the loft calculation facility 8 is integrated into the CAD application 6 as a tool. In another implementation, the loft calculation facility 8 is in communication with the CAD application 6 but is not part of the CAD application.

The raw scan data 4 is a collection of high resolution points in three dimensions representing the shape of a scanned object. In one implementation, the raw scan data 4 is a set of triangular meshes but the use of other forms of scan data is also considered to be within the scope of the present invention. For example, the raw scan data 4 may be points, quad meshes, tetrahedral meshes or hexahedral meshes. Collectively the set of meshes form a model 12 representing the surface of the scanned object. The model 12 may be a mesh model or a point cloud model. The model 12 may be segmented into multiple regions 14, 16 and 18. The regions 14, 16 and 18 may be segmented according to curvature values. The segmentation of the model 12 into the multiple regions 14, 16 and 18 may be performed manually by a user with the aid of a graphical user interface 32 displayed on a display device 30. Alternatively, the segmentation of the model 12 into the multiple regions 14, 16 and 18 may be performed programmatically with the aid of a segmentation software facility such as the one described in a co-pending United States Application entitled System and Method for Identifying Original Design Intents Using 3D Scan Data”, application Ser. No. 11/612,294, filed on Dec. 18, 2006.

The loft calculation facility 8 programmatically generates a loft surface based on the 3D scan data for a region or regions of the model 12 selected by a user 20. In one embodiment the graphical user interface (GUI) 32 on the display 30 in communication with the computing device 2 is used to select one or more regions 14, 16 and/or 18 of the model for which the user wishes to calculate a loft surface. As described further below, the GUI 32 enables a user to enter parameters which are then utilized by the loft calculation facility 8 in calculating a loft surface for the region or regions 14, 16 and/or 18 selected by the user 20.

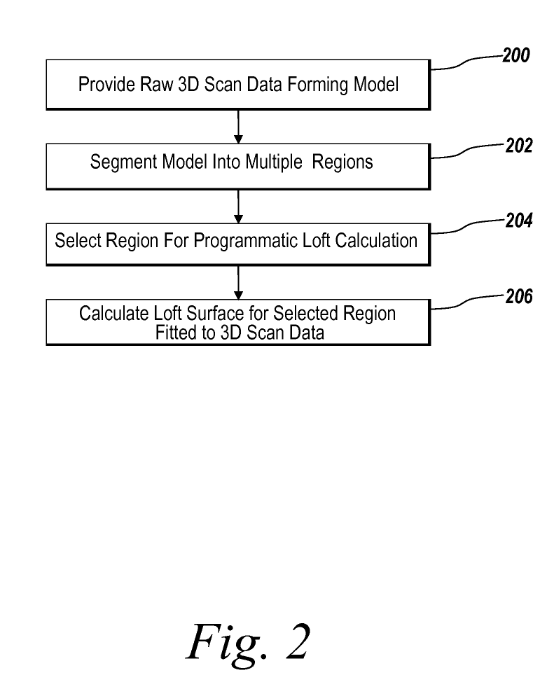

FIG. 2 is a flowchart of a sequence of steps that may be followed by an embodiment of the present invention to programmatically calculate a loft surface for a selected region using raw 3D scan data. The sequence of steps begins with the provision of a collection of raw 3D scan data 4 that collectively forms a model 12 (step 200). As noted above, the model 12 may be, for example, a mesh model or a point cloud model. The raw 3D scan data may be gathered as a dynamic part of the process of programmatically calculating a loft surface or may be previously stored scan data. The model 12 is then segmented into multiple regions 14, 16 and 18. The segmentation may be performed manually or alternatively may be performed programmatically by a segmentation facility in response to a user command to segment the model 12 into multiple regions 14, 16 and 18 (step 202). A user 20 viewing the model 12 on the display 30 may then use a GUI 32 to select one or more regions 14, 16 and/or 18 for programmatic loft calculation (step 204). For example, the user may select two geometrically separated regions which are to be connected by a loft surface. The loft calculation facility 8 then calculates the loft surface for the selected region or regions using the raw scan data 4 as set forth further below (step 206).

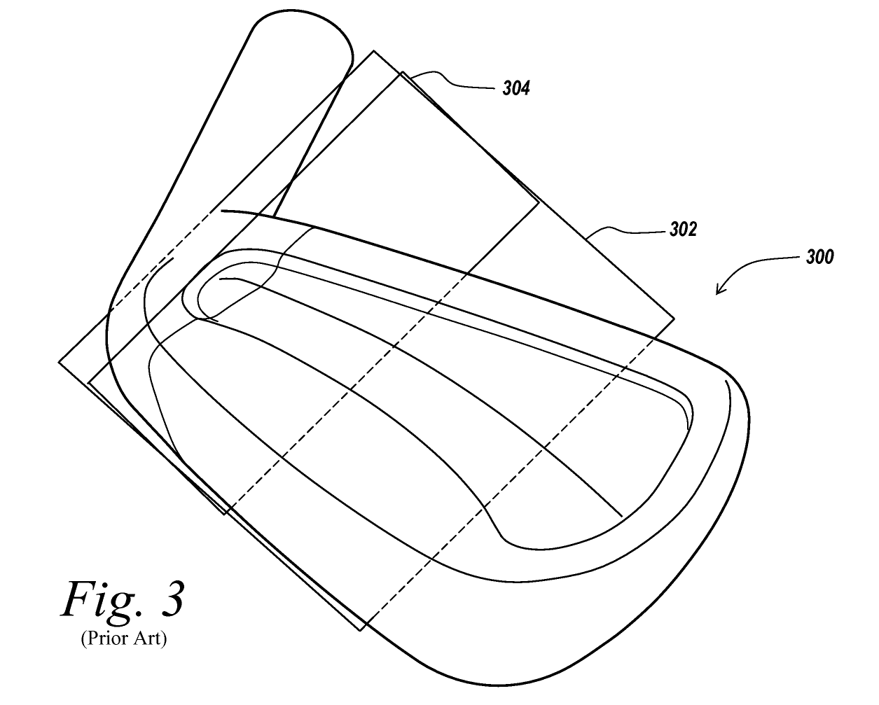

Before discussing the embodiments of the present invention in greater detail, a discussion of reverse engineering techniques and the manipulation of scan data during the calculation of loft surfaces in general is set forth. FIG. 3 depicts sample 3D scan data represented in a triangular mesh model 300. The mesh model 300 depicts the surface shape of a golf club. The user of the modeling software may insert planes 302 and 304 that intersect or form tangents to the surfaces contained in the model. The planes are used to define the section plane of profiles.

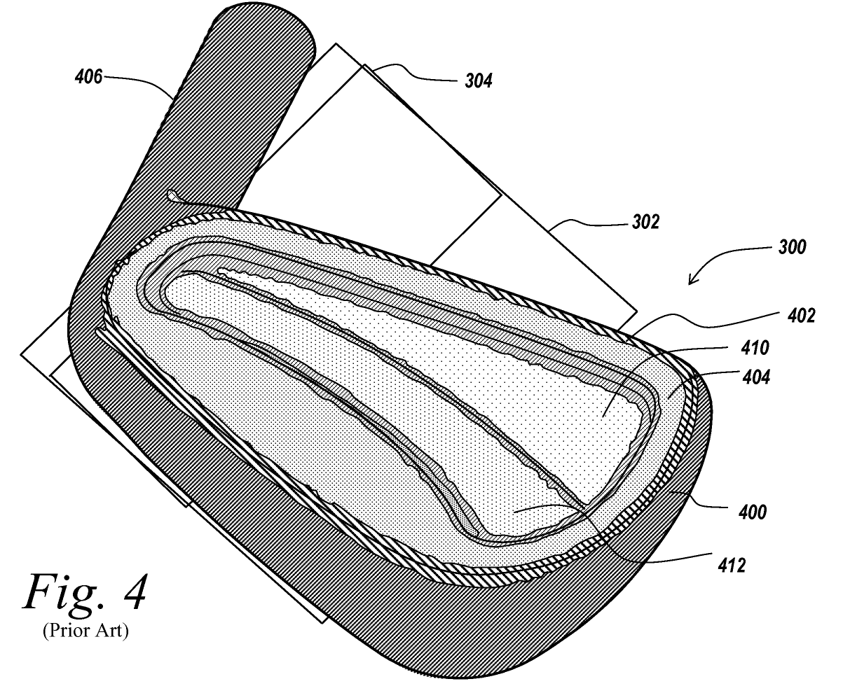

The user of the modeling software may group different areas of the model prior to performing different operations on the model. FIG. 4 depicts the grouping of the model 300 depicted in FIG. 3 into regions with similar curvature ranges. For example, the model 300 representing the cavity backed golf club in FIGS. 3 and 4 may include multiple areas of the model that are grouped into regions with similar curvature values by a user. The user may group a region of 3D scan data representing the shaft of the golf club 406 while another area representing the outside face of the toe of the golf club 400 may also be separately grouped. Similarly, the user may group different areas of the back of the golf club 402 and 404 and different areas of the cavity back 410 and 412. Once the areas of the model have been grouped into regions with similar curvature values, the user may design a loft surface to represent one of the areas, such as the area 404 on the back of the golf club.

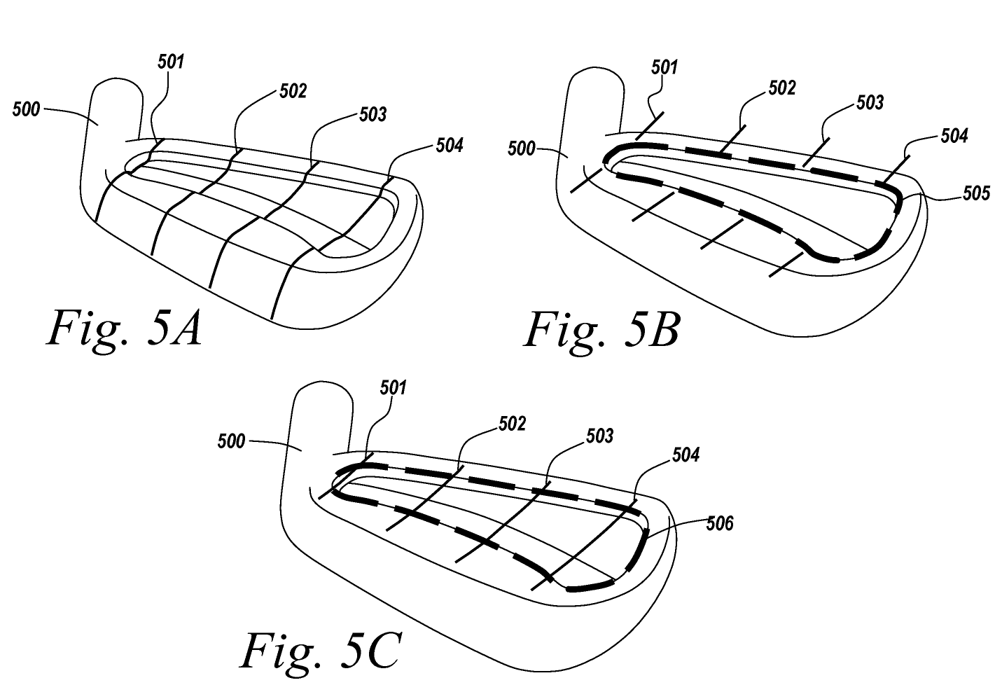

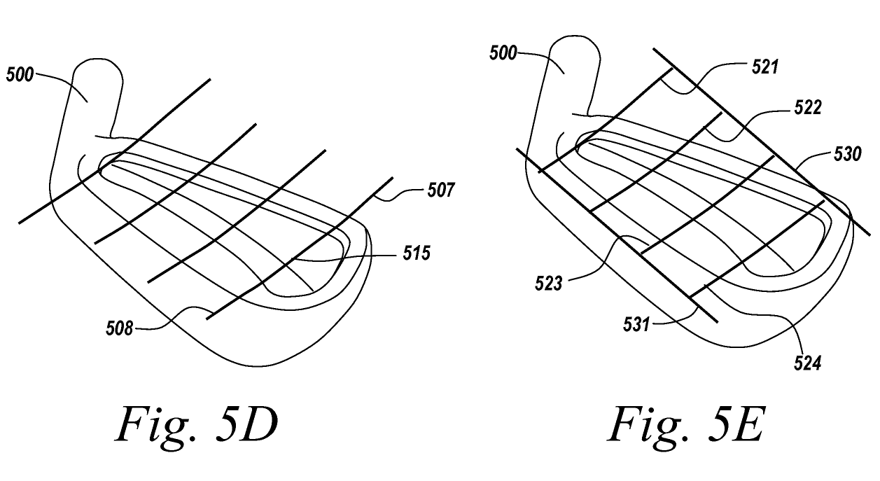

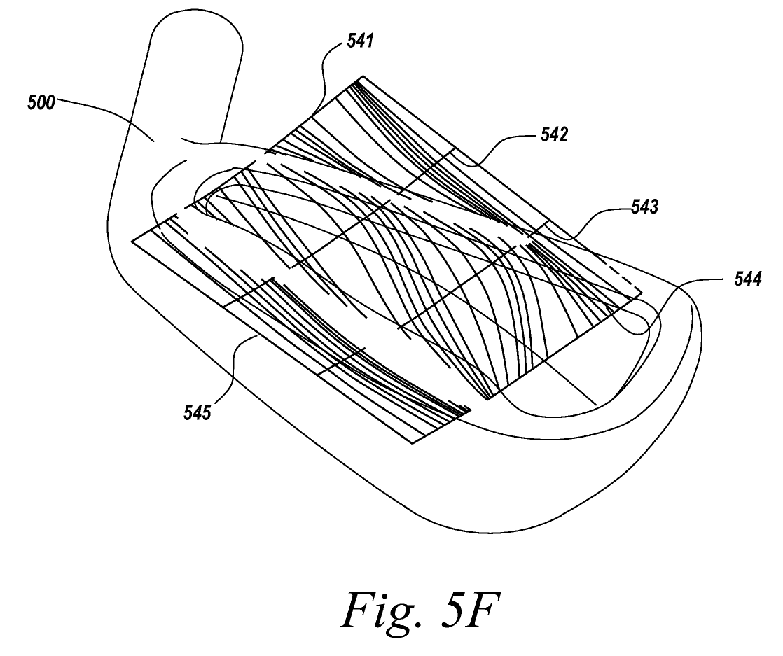

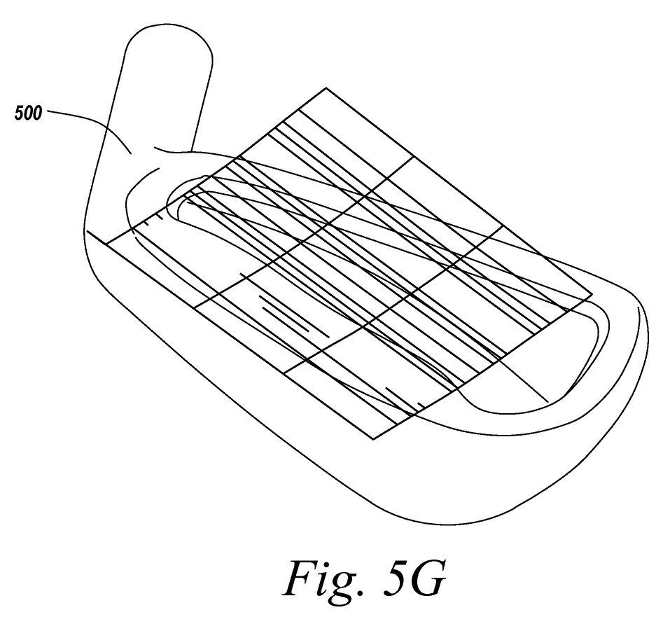

The process of designing a loft surface has conventionally required a user to manually perform a number of different types of loft modeling processes. For example, FIG. 5A depicts the application of cross section curves 501, 502, 503 and 504 to a model 500. FIG. 5B depicts the removal of a portion of cross section curves 501, 502, 503 and 504 from an area 505 of a model 500. Similarly, FIG. 5C depicts the reconnection of broken cross section curves 501, 502, 503 and 504 in an area 506 of a model. Another time consuming task in the designing of a loft surface is arranging for the correct length of cross section curves. FIG. 5D depicts the extension of the ends 517 and 518 of a cross section curve 515 while FIG. 5E depicts the trimming of the ends of cross section curves 521, 522, 523 and 524 with two planes 530 and 531 in order to have the endpoints of the cross section curves located on common planes.

Once the cross section curves have been placed and sized to the user's satisfaction, the cross section curves may be used as section profiles in a loft surface that the user is designing. FIG. 5F depicts the use of cross section curves as section profiles 541, 542, 543 and 544 when defining a loft surface 540. Following the determination of the section profiles, the user may attempt to enhance the continuity of the loft surface by straightening/smoothing the curved flow of the iso-curve of the loft surface being designed. The user may also attempt to make the surface smoother by generating and rebuilding cross section curves. FIG. 5G depicts the approximation of the loft surface 540 with a straight isometric curve flow 540. 3D scan data geometry which is represented as a model, such as a mesh model or point cloud model, holds shape information for a 3D object being redesigned even though it is rougher and non-continuous compared to a parametric surface model. The 3D scan data may be used to calculate loft surfaces. As noted above the conventional techniques of modeling loft surfaces require the user to manually and iteratively perform the techniques discussed previously with regard to FIG. 3, FIG. 4 and FIGS. 5A-5G. In contrast to the conventional techniques of modeling loft surfaces, the embodiments of the present invention provide a programmatic calculation of a loft surface for the 3D scan data that automatically applies parameters received from a user in calculating a loft surface.

The model 12 that is based on the 3D scan data 4 is grouped into multiple regions by the user based on the curvature values of areas of the model. As noted above, this grouping may occur programmatically or manually. The embodiments of the present invention provide a graphical user interface that allows a user to choose a region or regions of the model for which a loft surface will be created. As input arguments, users also can specify U-V direction, guide curves and/or allowable deviation error. The loft calculation facility 8 generates all of the necessary profile curves meeting given parameters and creates a loft surface passing through the generated profile curves. Curves intersecting the region selected for programmatic loft calculation may be automatically extended as part of the calculation of the loft surface.

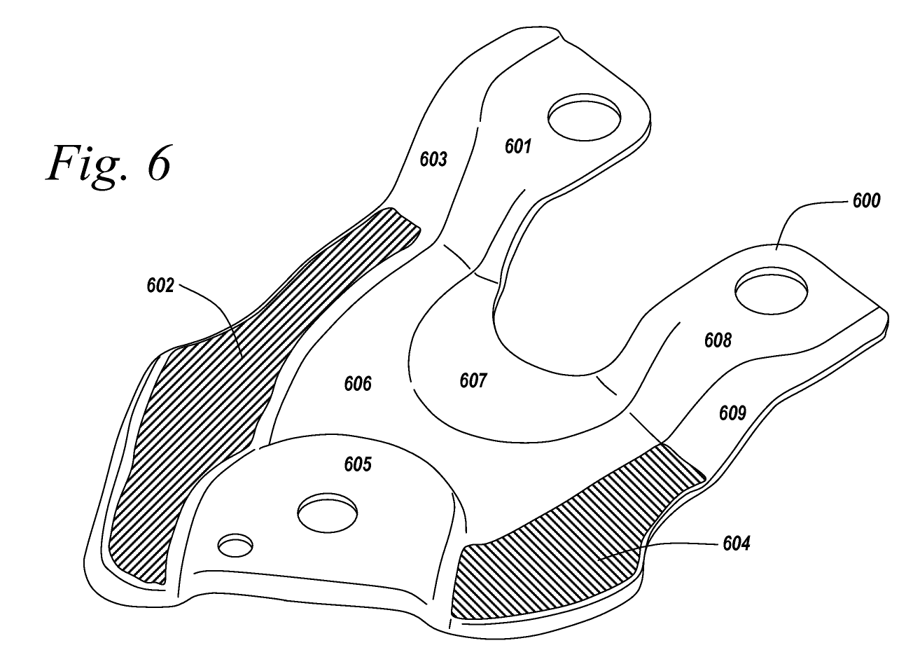

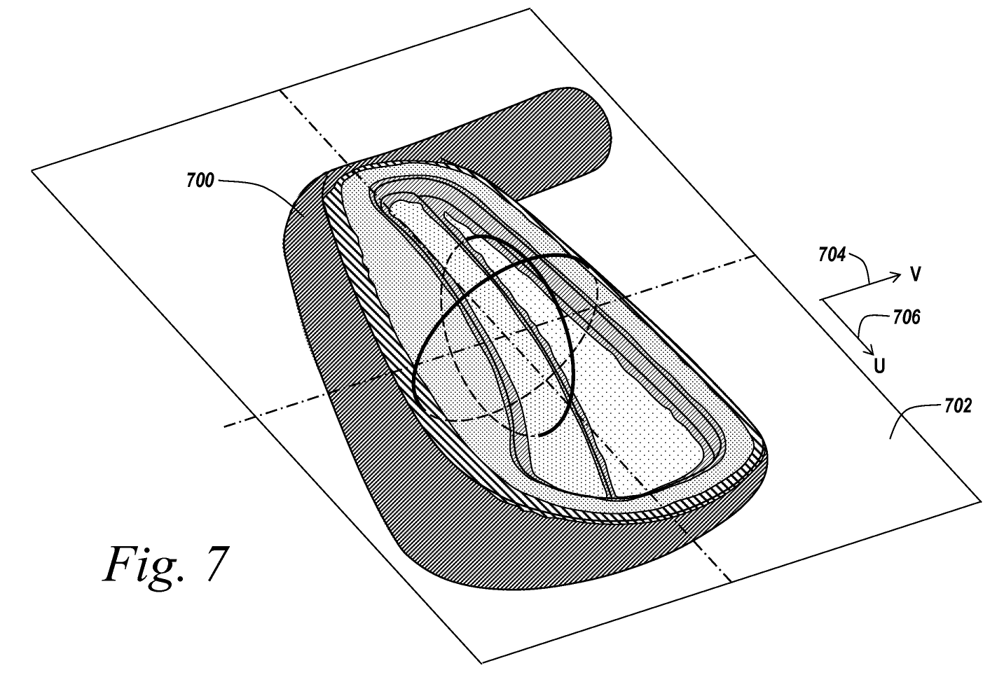

In one embodiment, users can choose geometrically separated regions in order to create a single loft surface that connects the separated regions. For example, FIG. 6 depicts a model 600 which includes multiple regions 601-608. The graphical user interface 32 allows the user to select geometrically separated regions 602 and 604. The loft calculation facility 8 then programmatically calculates a loft surface that connects the selected regions 602 and 604.

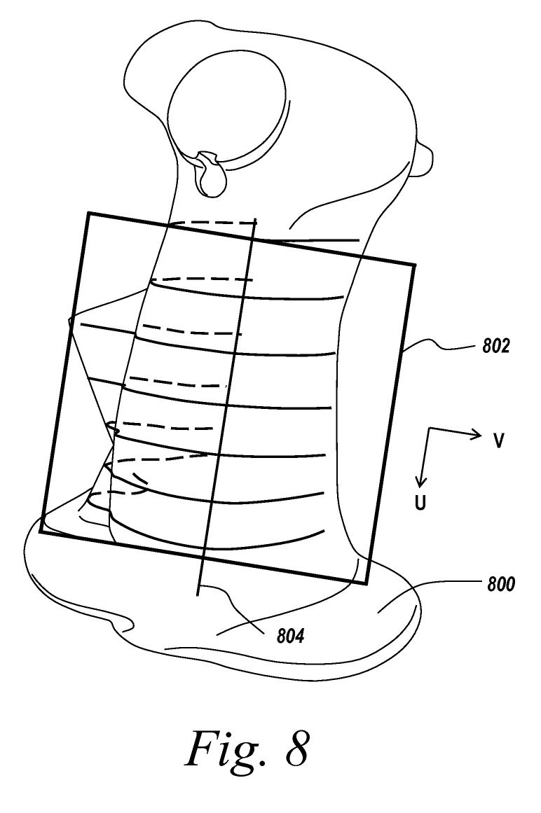

The graphical user interface 32 also allows the user to specify the U-V direction (iso-flow direction) of the calculated loft surface by graphically orienting a rectangular graphic component in a displayed view of the model. For example, FIG. 7 depicts one illustrative embodiment of the graphical user interface 32 that enables the selection of a U-V direction 704 by orienting a rectangular plane 702 that is overlaid on a model 700. To change the U-V direction in this implementation, the user selects the plane 702 and moves it to a desired location. Section curves can be generated along the U direction and used as profile curves for the loft surface calculated by the loft calculation facility.

A user is also able to specify guide curves that are utilized in the calculation of the loft surface. The guide curve passes through all the profile curves and the loft surface is created on the profile and guide curve at the same time. The graphical user interface 32 allows the user to select a guide curve, including pre-existing guide curves. Alternatively, the user may use the graphical user interface 32 to select feature regions of the model to be used as guide curves. For example, FIG. 8 depicts one illustrative embodiment of the graphical user interface 32 that enables the user to select a guide curve to be used in the calculation of the loft surface by the loft calculation facility 8. The graphical user interface 32 displays a model 800 which includes an overlaid rectangular graphical component 802 corresponding to the selected U-V direction. The graphical user interface 32 allows the user to select the guide curve 804 to be used in the calculation of a loft surface for the model 800.

As discussed above the graphical user interface may allow the user to use feature regions as guide curves to be used in the calculation of a loft surface. More specifically, the user may use feature curves from different regions of the model, such as a fillet region (an edge region) of the model. There are a number of different ways to create the feature curves from the feature regions. For example, the graphical user interface 32 may include a 3D sketch mode from which the user can select a command to trace a feature in the model so as to create a feature curve. As another example, the user may use an interpolated curves created from reference polylines which are automatically or semi-automatically extracted from feature shapes.

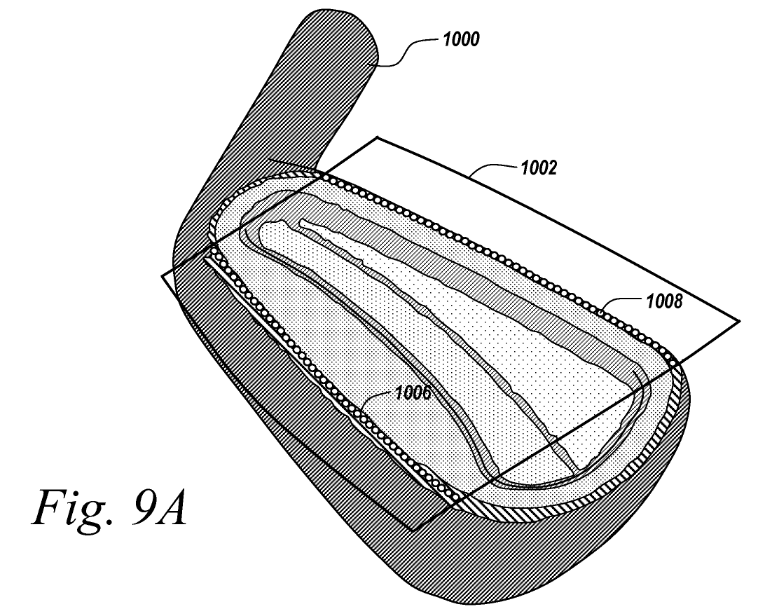

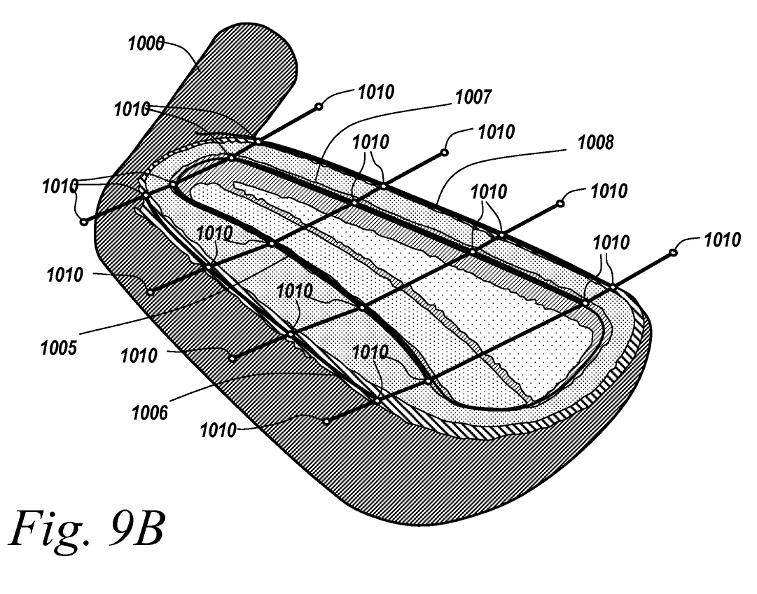

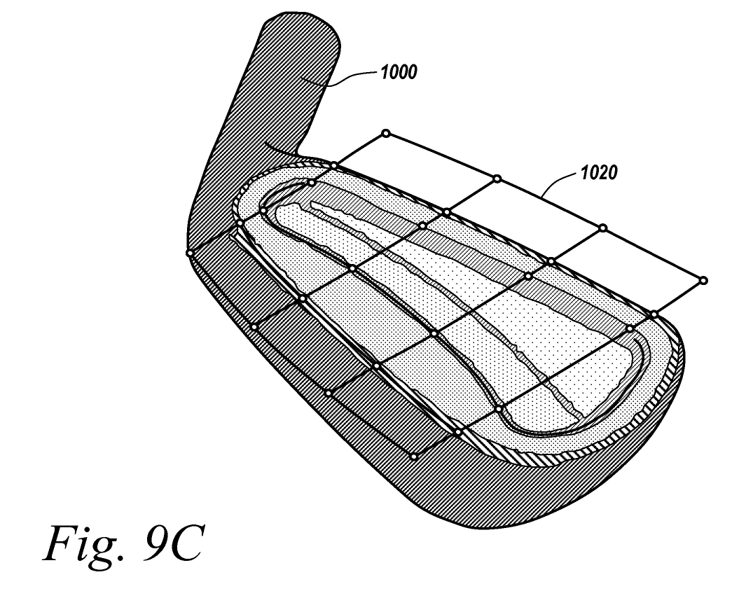

The guide curves created from feature regions of the model intersect the profile curves used to calculate a loft surface. Conventionally, repetitive user manual operations have been required to use feature curves as guide curves so that the points of intersection are correct. The present invention provides a mechanism for addressing this problem of using feature curves. An initial loft surface with no guide curves (an “unguided loft surface”) is projected on the model. The feature curve is then selected by the user and projected on the unguided loft surface. Any unnecessary portion of the feature curves is trimmed with the edge of the surface boundary. FIG. 9A depicts the use of an unguided loft surface by an embodiment of the present invention. An unguided loft surface 1002 is placed on the model 1000. Feature curves 1006 and 1008 are selected by a user and trimmed by the edge of the unguided loft surface 1002.

Following the application of the feature curve to the unguided loft surface, the loft calculation facility 8 identifies the nodes of intersection between the feature curves and the profile curves that have been provide for the loft surface using the techniques discussed above. In one embodiment, the graphical user interface 32 may accept user commands that instruct the loft calculation facility to iteratively rebuild the guide curves into smooth isometric-flow lines while considering the deviation between the final calculated loft surface with the guide curves and the model data. FIG. 9B depicts the nodes of intersection 1010 between feature curves 1005, 1006, 1007 and 1008. FIG. 9C depicts the final calculated loft surface 1020 calculated for the model 1000 using the feature curves as guide curves.

In one aspect of the present invention, the graphical user interface 32 allows a user to specify the amount of allowable deviation error between the calculated loft surface and the underlying 3D scan geometry. Deviation may be calculated using various methods. The simplest method works from the reference mesh/model and per polygon, finds the closest Polygon Center, Edge or Vertex of the other mesh/model. This distance result represents the deviation. A more complicated approach works on a per polygon basis where the normal direction of the polygon is determined and a search in this direction for the nearest polygon in the other mesh/model is conducted with the distance result representing the deviation. The loft calculation facility 8 determines how many profile curves are needed and where the profile curves should be located in order to calculate the desired loft surface for the selected region.

In another aspect of the present invention, the graphical user interface 32 allows a user to supply start and end profiles with boundary conditions to generate a loft surface smoothly connected to an existing body.

In one embodiment, the loft calculation facility allows a user to approximate the loft surface by straightening/smoothing the curved flow of the iso-curve of the loft surface being designed. The user may attempt to make the surface smoother by generating and rebuilding cross section curves for programmatic loft calculation. The loft calculation facility may automatically calculate how many cross section curves are needed and where the curves should be located based on a user-specified deviation error. The result of the rebuilding of the cross-section curves is a smoother and better looking surface than is possible with conventional techniques.

In one embodiment, the loft calculation facility automatically updates a loft surface if there are changes in the scan data or the amount of user-specified deviation error. The updated loft surface may be displayed to a user for approval.

The present invention may be provided as one or more computer-readable programs embodied on or in one or more mediums. The mediums may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include FORTRAN, C, C++, C#, or JAVA. The software programs may be stored on or in one or more mediums as object code. Hardware acceleration may be used and all or a portion of the code may run on a FPGA or an ASIC. The code may run in a virtualized environment such as in a virtual machine. Multiple virtual machines running the code may be resident on a single processor.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

We claim:

1. A method for creating loft surfaces using three-dimensional (3D) scan data, comprising:
providing a collection of 3D scan data representing the shape of a three dimensional object, the 3D scan data combined into a model representing the three dimensional object;
segmenting the model into a plurality of regions;
selecting at least one region for programmatic loft calculation; and
calculating programmatically a loft surface fitted to the 3D scan data.

2. The method of claim 1 wherein the model is a mesh model.

3. The method of claim 1 wherein the model is a point cloud model.

4. The method of claim 1, further comprising:
providing a user interface, the user interface enabling a selection of at least one parameter related to the programmatic calculation of the loft surface.

5. The method of claim 4 wherein the at least one parameter is the user specification of an allowable deviation error.

6. The method of claim 4 wherein the at least one parameter is the user specification of a U-V direction.

7. The method of claim 4 wherein the at least one parameter is the user specification of a guide curve.

8. The method of claim 4 wherein the at least one parameter is the user specification of at least one of a start and end profile with at least one boundary condition.

9. The method of claim 4 wherein the at least one parameter is the user-specification of an allowable deviation error and wherein the programmatic calculation of a loft surface fitted to the 3D scan data further comprises:
generating programmatically at least two cross section curves intersecting the region selected for programmatic loft calculation, the generating including a calculation for a location for each of the at least two cross-section curves based on the user-specified deviation error..

10. The method of claim 1 wherein the programmatic calculation of a loft surface fitted to the 3D scan data further comprises:
calculating programmatically a U-V direction from geometric characteristics of the at least one region.

11. The method of claim 1 wherein the programmatic calculation of a loft surface fitted to the 3D scan data further comprises:
connecting smoothly at least one broken curve intersecting the region selected for programmatic loft calculation.

12. The method of claim 1 wherein the programmatic calculation of a loft surface fitted to the 3D scan data further comprises:
extending at least one curve intersecting the region selected for programmatic loft calculation.

13. The method of claim 1 wherein the programmatic calculation of a loft surface fitted to the 3D scan data further comprises:
trimming a plurality of curves that intersect a region selected for programmatic loft calculation so that respective endpoints for the plurality of curves are located on one of a common plane or a smooth curve extending from a region boundary.

14. The method of claim 1 wherein the programmatic calculation of a loft surface fitted to the 3D scan data further comprises:
using a plurality of cross section curves intersecting the region selected for programmatic loft calculation as section profiles.

15. The method of claim 1 wherein the programmatic calculation of a loft surface fitted to the 3D scan data further comprises:
approximating the loft surface so as to straighten an iso-flow curve by at least one of generating and rebuilding cross-section curves intersecting the region selected for programmatic loft calculation.

16. The method of claim 1 wherein at least two geometrically separate regions are selected for programmatic loft calculation and the calculated loft surface connects the 3D scan data for the at least two geometrically separate regions.

17. The method of claim 1, further comprising:
programmatically calculating a guide curve for use in calculating the loft surface, the guide curve calculated from the user selected at least one region.

18. A system for use with a computing device for programmatically creating loft surfaces using three-dimensional (3D) scan data, comprising:
a collection of 3D scan data representing the shape of a three dimensional object, the 3D scan data combined into a model representing the three dimensional object, the model segmented into a plurality of regions;
a loft calculation facility for programmatically calculating a loft surface fitted to the 3D scan data for at least one of the plurality of regions; and
a display device, the display device displaying a user interface enabling a selection of at least one parameter related to the programmatic calculation of the loft surface.

19. The system of claim 18, further comprising:
a 3D scanner for collecting the collection of 3D scan data.

20. A physical medium holding computer-executable instructions for creating loft surfaces using three-dimensional (3D) scan data, the medium comprising:
instructions for providing a collection of 3D scan data representing the shape of a three dimensional object, the 3D scan data combined into a model representing the three dimensional object;
instructions for segmenting the model into a plurality of regions;
instructions for selecting at least one region for programmatic loft calculation; and
instructions for calculating programmatically a loft surface fitted to the 3D scan data.

21. The medium of claim 20 wherein the model is a mesh model.

22. The medium of claim 20 wherein the model is a point cloud model.

23. The medium of claim 20 wherein the medium further comprises:
instructions for providing a user interface, the user interface enabling a selection of at least one parameter related to the programmatic calculation of the loft surface.

24. The medium of claim 23 wherein the at least one parameter is the user specification of an allowable deviation error.

25. The medium of claim 23 wherein the at least one parameter is the user specification of a U-V direction.

26. The medium of claim 23 wherein the at least one parameter is the user specification of a guide curve.

27. The medium of claim 23 wherein the at least one parameter is the user specification of at least one of a start and end profile with at least one boundary condition.

28. The medium of claim 23 wherein the at least one parameter is the user-specification of an allowable deviation error and wherein the programmatic calculation of a loft surface fitted to the 3D scan data further comprises:
instructions for generating programmatically at least two cross section curves intersecting the region selected for programmatic loft calculation, the generating including a calculation for a location for each of the at least two cross-section curves based on the user-specified deviation error.

29. The medium of claim 20 wherein the programmatic calculation of a loft surface fitted to the 3D scan data further comprises:
instructions for calculating programmatically a U-V direction from geometric characteristics of the at least one region.

30. The medium of claim 20 wherein the programmatic calculation of a loft surface fitted to the 3D scan data further comprises:
instructions for connecting smoothly at least one broken curve intersecting the region selected for programmatic loft calculation.

31. The medium of claim 20 wherein the programmatic calculation of a loft surface fitted to the 3D scan data further comprises:
instructions for extending at least one curve intersecting the region selected for programmatic loft calculation.

32. The medium of claim 20 wherein the programmatic calculation of a loft surface fitted to the 3D scan data further comprises:
instructions for trimming a plurality of curves that intersect a region selected for programmatic loft calculation so that respective endpoints for the plurality of curves are located on one of a common plane or a smooth curve extending from a region boundary.

33. The medium of claim 20 wherein the programmatic calculation of a loft surface fitted to the 3D scan data further comprises:
instructions for using a plurality of cross section curves intersecting the region selected for programmatic loft calculation as section profiles.

34. The medium of claim 20 wherein the programmatic calculation of a loft surface fitted to the 3D scan data further comprises:
instructions for approximating the loft surface so as to straighten an iso-flow curve by at least one of generating and rebuilding cross-section curves intersecting the region selected for programmatic loft calculation.

35. The medium of claim 20 wherein at least two geometrically separate regions are selected for programmatic loft calculation and the calculated loft surface connects the 3D scan data for the at least two geometrically separate regions.

36. The medium of claim 20, wherein the medium further comprises:
instructions for automatically updating the loft surface based on a change in the scan data or an amount of user-specified deviation error.
